(19) United States
(12) Patent Application Publication
(10) Pub. No.: US 2025/0319877 A1
(43) Pub. Date: Oct. 16, 2025

(54) APPARATUS AND METHOD FOR CONTROLLING UNMANNED DRIVING OF AN AUTONOMOUS VEHICLE

(71) Applicants: HYUNDAI MOTOR COMPANY, Seoul (KR); KIA CORPORATION, Seoul (KR)

(72) Inventors: Byeong Wook Jeon, Hwaseong-si (KR); Jung Hwan Bang, Hwaseong-si (KR); Won Seok Jeon, Hwaseong-si (KR); Dong Hoon Won, Hwaseong-si (KR); Dong Hoon Jeong, Hwaseong-si (KR)

(73) Assignees: HYUNDAI MOTOR COMPANY, Seoul (KR); KIA CORPORATION, Seoul (KR)

(21) Appl. No.: 18/915,043

(22) Filed: Oct. 14, 2024

(30) Foreign Application Priority Data
Apr. 11, 2024 (KR) 10-2024-0048804

(51) Int. Cl. B60W 30/182; B60W 20/13; B60W 30/14; B60W 30/16; B60W 40/09; B60W 50/00; B60W 60/00

(52) U.S. Cl. CPC B60W 30/182; B60W 20/13; B60W 30/143; B60W 30/16; B60W 40/09; B60W 50/0097; B60W 60/001; B60W 2420/408; B60W 2510/0657; B60W 2520/105; B60W 2520/28; B60W 2530/10; B60W 2552/15; B60W 2552/30; B60W 2554/802; B60W 2556/40

(57) ABSTRACT

An autonomous driving control apparatus includes a memory that stores computer-executable instructions. The apparatus also includes a processor that executes the instructions by accessing the memory. The processor controls the target vehicle in a first control mode based on a first driving status of a target vehicle, a second driving status of a forward vehicle driving around the target vehicle, or any combination thereof. The processor releases the first control mode applied to the target vehicle by satisfying the conversion condition that the control mode applicable to the target vehicle is capable of being converted from the second control mode to the first control mode. The processor controls the target vehicle in the second control mode, based on the first driving status, the second driving status, the state of the driver of the target vehicle, energy consumption predicted according to information about a front road, or any combination thereof.

### CROSS-REFERENCE TO RELATED APPLICATION

This application claims the benefit of and priority to Korean Patent Application No. 10-2024-0048804, filed in the Korean Intellectual Property Office on Apr. 11, 2024, the entire contents of which are incorporated herein by reference.

### TECHNICAL FIELD

The present disclosure relates to an autonomous driving control apparatus and an autonomous driving control method, and more particularly, the present disclosure relates to a technology for controlling the speed of a vehicle to minimize energy consumption.

### BACKGROUND

Among a vehicle's functions, cruise control is designed to accurately follow the speed set by a driver. Moreover, smart cruise control (SCC) is an improved cruise control. The SCC may reduce speed by recognizing the distance or relative speed to a forward vehicle for driving safety or may temporarily reduce a speed under a specific obstacle condition by using functions of reducing the speed in advance on roads, on which speed cameras are installed, curved roads, and the like. However, the SCC is designed to accurately follow a goal speed set by the driver under most driving conditions. In this process, there is no process of arbitrarily changing the speed to reduce energy consumption during driving.

To address these challenges, it is necessary to develop a technology that changes the speed of the vehicle in a target speed section including the goal speed so as to identify the context of driving by recognizing front roads and traffic conditions and to minimize the energy required to drive according to the identified conditions in front of the vehicle. The subject matter described in this background section is intended to promote an understanding of the background of the disclosure and thus may include subject matter that is not already known to those of ordinary skill in the art.

### SUMMARY

The present disclosure was made to solve the above-mentioned problems occurring in the prior art while advantages achieved by the prior art are maintained intact.

An aspect of the present disclosure provides an autonomous driving control apparatus that may realizes a cruise control function with improved overall performance compared to the cruise control function of following a goal speed. The apparatus may perform acceleration and deceleration according to a driver's state, by controlling a target vehicle in a control mode based on a driving status of the target vehicle, a driving status of the forward vehicle, the state of the driver, and the predicted energy consumption. In the control mode, the speed of the target vehicle follows a target speed section. The present disclosure also provides an autonomous driving control method thereof.

An aspect of the present disclosure provides an autonomous driving control apparatus that may identify the context of driving by recognizing the shape of the front road, events on a front road, and traffic volume on the front road and may improve fuel efficiency by changing driving speed based on the identified context, by controlling the target vehicle based on a first prediction area capable of identifying the forward vehicle and a second prediction area determined by map information. The present disclosure also provides an autonomous driving control method thereof.

An aspect of the present disclosure provides an autonomous driving control apparatus that may provide a control mode that reflects energy consumption and the driver's acceleration/deceleration tendency according to the driver's needs by applying the sensitivity of a conversion condition between a first control mode and a second control mode to control torque. The present disclosure also provides an autonomous driving control method thereof.

The technical problems to be solved by the present disclosure are not limited to the aforementioned problems. Any other technical problems not mentioned herein should be clearly understood from the following description by those having ordinary skill in the art to which the present disclosure pertains.

According to an aspect of the present disclosure, an autonomous driving control apparatus may include a memory that stores computer-executable instructions. The apparatus may also include at least one processor that executes the computer-executable instructions by accessing the memory. The at least one processor may identify at least one of a first driving status of a target vehicle, a second driving status of a forward vehicle driving around the target vehicle, a state of a driver of the target vehicle, energy consumption predicted according to information about a front road, or any combination thereof. The at least one processor may control the target vehicle in a first control mode, in which a speed of the target vehicle follows a target speed section including a goal speed, based on at least one of the first driving status, the second driving status, the state of the driver of the target vehicle, the energy consumption, or any combination thereof. In the first control mode, a speed of the target vehicle follows a target speed section including a goal speed.

In an embodiment, the at least one processor may identify the first driving status based on at least one of the goal speed received from the driver, a goal distance, the speed of target vehicle, map information of the front road obtained from a navigation of the target vehicle, information of a brake pedal sensor (BPS) of the target vehicle, or any combination thereof. The goal distance is received together with the goal speed and which is a keeping distance between the forward vehicle and the target vehicle. The at least one processor may identify the second driving status including a distance between the target vehicle and the forward vehicle based on at least one of a RADAR sensor, a LiDAR sensor, or any combination thereof. The RADAR sensor, the LiDAR sensor, or any combination thereof is included in the target vehicle. The at least one processor may determine second control torque of a second control mode, based on at least one of the first driving status, the second driving status, or any combination thereof. In the second control mode, the speed of the target vehicle follows the goal speed. The at least one processor may control the target vehicle such that the speed of the target vehicle follows the goal speed, by applying the second control torque to the target vehicle.

In an embodiment, the at least one processor may determine a first prediction area. The first prediction area is an area where the forward vehicle is capable of being identified by at least one of a RADAR sensor, or a LiDAR sensor, or any combination thereof. The RADAR sensor, the LiDAR sensor, or any combination thereof is included in the target vehicle. The at least one processor may determine a second prediction area. The second prediction area is an area spaced from a location of the target vehicle by a predetermined distance in map information of the front road obtained from a navigation of the target vehicle. The at least one processor may control the target vehicle in the first control mode based on the second driving status and the predicted energy consumption. The second driving status is obtained through the first prediction area, and the predicted energy consumption is obtained through the second prediction area.

In an embodiment, the at least one processor may determine at least one of a distance between the target vehicle and the forward vehicle, a relative speed between the target vehicle and the forward vehicle, or any combination thereof by identifying the forward vehicle in the first prediction area. The at least one processor may determine at least one of a gradient of the front road, curvature of the front road, or any combination thereof based on the map information in the second prediction area. The at least one processor may control the target vehicle in the first control mode based on at least one of the distance between the target vehicle and the forward vehicle, the relative speed between the target vehicle and the forward vehicle, the gradient of the front road, the curvature of the front road, or any combination thereof.

In an embodiment, the at least one processor may identify the first driving status based on weight of the target vehicle determined based on at least one of acceleration of the target vehicle, the speed of the target vehicle, longitudinal acceleration of the target vehicle, a wheel speed of the target vehicle, or any combination thereof. The at least one processor may identify the state of the driver based on an acceleration/deceleration tendency of the driver determined repeatedly for a predetermined period of time. The at least one processor may determine first control torque of the first control mode based on at least one of the first driving status, the second driving status, the state of the driver, or any combination thereof. The at least one processor may control the target vehicle such that the speed of the target vehicle follows the target speed section, by applying the first control torque to the target vehicle.

In an embodiment, the at least one processor may release the first control mode applied to the target vehicle by identifying an external device configured to detect a speed at a predetermined distance based on a location of the target vehicle from the first driving status.

In an embodiment, the at least one processor may release the first control mode applied to the target vehicle by identifying that the distance between the forward vehicle and the target vehicle is smaller than or equal to a predetermined distance from the second driving status.

In an embodiment, the at least one processor may determine sensitivity of an inverse conversion condition that a control mode of the target vehicle is capable of being converted from the first control mode to the second control mode, based on an external device configured to detect a speed at a predetermined distance being identified based on a location of the target vehicle, or the distance between the forward vehicle and the target vehicle being smaller than or equal to a predetermined distance. The at least one processor may control the target vehicle such that the speed of the target vehicle follows the target speed section, by applying the first control torque, to which the sensitivity is reflected. The target vehicle to which the first control mode is applied to the target vehicle.

In an embodiment, the at least one processor may release the first control mode applied to the target vehicle. The at least one processor may control the target vehicle in the second control mode based on the target vehicle. The first control mode is applied to the target vehicle, satisfying an inverse conversion condition that a control mode of the target vehicle is capable of being converted from the first control mode to the second control mode. The inverse conversion condition may be determined by the first driving status, the second driving status, and the state of the driver.

In an embodiment, the at least one processor may identify driving information for determining a driving tendency of the driver based on at least one of the first driving status, the second driving status, or any combination thereof not being identified. The at least one processor may store an acceleration/deceleration tendency of the driver obtained from the driving information in the target vehicle at a predetermined time interval.

In an embodiment, the at least one processor may obtain first control torque of the first control mode by applying the first driving status, the second driving status, the state of the driver, and weight of the target vehicle to a torque calculation model trained to determine control torque for reducing energy consumption. The at least one processor may control the target vehicle such that the speed of the target vehicle follows the target speed section, by applying the first control torque to the target vehicle.

In an embodiment, the target vehicle may include an electric vehicle that moves by applying the first control torque to a drive motor.

According to an aspect of the present disclosure, an autonomous driving control method may include identifying at least one of a first driving status of a target vehicle, a second driving status of a forward vehicle driving around the target vehicle, a state of a driver of the target vehicle, energy consumption predicted according to information about a front road, or any combination thereof. The method may include controlling the target vehicle in a first control mode, based on at least one of the first driving status, the second driving status, the state of the driver of the target vehicle, the energy consumption, or any combination thereof. In the first control mode, a speed of the target vehicle follows a target speed section including a goal speed,

In an embodiment, controlling the target vehicle in the first control mode may include identifying the first driving status based on at least one of the goal speed received from the driver, a goal distance, the speed of target vehicle, map information of the front road obtained from a navigation of the target vehicle, information of a BPS of the target vehicle, or any combination thereof. The goal distance is received together with the goal speed and which is a keeping distance between the forward vehicle and the target vehicle. Controlling the target vehicle in the first control mode may include identifying the second driving status including a distance between the target vehicle and the forward vehicle based on at least one of a RADAR sensor, a LiDAR sensor, or any combination thereof. The RADAR sensor, the LiDAR sensor, or any combination thereof is included in the target vehicle. Controlling the target vehicle in the first control mode may include determining second control torque of a second control mode, based on at least one of the first driving status, or the second driving status, or any combination thereof. In the second control mode, the speed of the target vehicle follows the goal speed. Controlling the target vehicle in the first control mode may include controlling the target vehicle such that the speed of the target vehicle follows the goal speed, by applying the second control torque to the target vehicle.

In an embodiment, controlling the target vehicle in the first control mode may include determining a first prediction area. The first prediction area is an area where the forward vehicle is capable of being identified by at least one of a RADAR sensor, a LiDAR sensor, or any combination thereof. The RADAR sensor, the LiDAR sensor, or any combination thereof is included in the target vehicle. Controlling the target vehicle in the first control mode may include determining a second prediction area. The second prediction area is an area spaced from a location of the target vehicle by a predetermined distance in map information of the front road obtained from a navigation of the target vehicle. Controlling the target vehicle in the first control mode may include controlling the target vehicle in the first control mode based on the second driving status and the predicted energy consumption obtained through the second prediction area. The second driving status is obtained through the first prediction area. Controlling the target vehicle in the first control mode may include determining at least one of a distance between the target vehicle and the forward vehicle, a relative speed between the target vehicle and the forward vehicle, or any combination thereof by identifying the forward vehicle in the first prediction area. Controlling the target vehicle in the first control mode may include determining at least one of a gradient of the front road, curvature of the front road, or any combination thereof based on the map information in the second prediction area. Controlling the target vehicle in the first control mode may include controlling the target vehicle in the first control mode based on at least one of the distance between the target vehicle and the forward vehicle, the relative speed between the target vehicle and the forward vehicle, the gradient of the front road, the curvature of the front road, or any combination thereof.

In an embodiment, controlling the target vehicle in the first control mode may include identifying the first driving status based on weight of the target vehicle determined based on at least one of acceleration of the target vehicle, the speed of the target vehicle, longitudinal acceleration of the target vehicle, a wheel speed of the target vehicle, or any combination thereof. Controlling the target vehicle in the first control mode may include identifying the state of the driver based on an acceleration/deceleration tendency of the driver determined repeatedly for a predetermined period of time. Controlling the target vehicle in the first control mode may include determining first control torque of the first control mode based on at least one of the first driving status, the second driving status, the state of the driver, or any combination thereof. Controlling the target vehicle in the first control mode may include controlling the target vehicle such that the speed of the target vehicle follows the target speed section, by applying the first control torque to the target vehicle.

In an embodiment, controlling the target vehicle in the first control mode may include releasing the first control mode applied to the target vehicle by identifying an external device configured to detect a speed at a predetermined distance based on a location of the target vehicle from the first driving status. Controlling the target vehicle in the first control mode may include releasing the first control mode applied to the target vehicle by identifying that a distance between the forward vehicle and the target vehicle is smaller than or equal to a predetermined distance from the second driving status. Controlling the target vehicle in the first control mode may include determining sensitivity inverse conversion condition that a control mode of the target vehicle is capable of being converted from the first control mode to a second control mode, based on an external device configured to detect a speed at a predetermined distance being identified based on a location of the target vehicle, or the distance between the forward vehicle and the target vehicle being smaller than or equal to a predetermined distance. Controlling the target vehicle in the first control mode may include controlling the target vehicle such that the speed of the target vehicle follows the target speed section, by applying the first control torque, to which the sensitivity is reflected, to the target vehicle. The first control mode is applied to the target vehicle.

In an embodiment, controlling the target vehicle in the first control mode may include releasing the first control mode applied to the target vehicle. Controlling the target vehicle in the first control mode may include controlling the target vehicle in the second control mode based on the target vehicle. The first control mode is applied to the target vehicle, satisfying an inverse conversion condition that a control mode of the target vehicle is capable of being converted from the first control mode to the second control mode. The inverse conversion condition may be determined by the first driving status, the second driving status, and a state of the driver.

In an embodiment, the autonomous driving control method may further include identifying driving information for determining a driving tendency of the driver based on at least one of the first driving status, the second driving status, or any combination thereof not being identified. The method may further include storing an acceleration/deceleration tendency of the driver obtained from the driving information in the target vehicle at a predetermined time interval.

In an embodiment, controlling the target vehicle in the first control mode may include obtaining first control torque of the first control mode by applying the first driving status, the second driving status, the state of the driver, and weight of the target vehicle to a torque calculation model trained to determine control torque for reducing energy consumption. Controlling the target vehicle in the first control mode may include controlling the target vehicle such that the speed of the target vehicle follows the target speed section, by applying the first control torque to the target vehicle.

### BRIEF DESCRIPTION OF THE DRAWINGS

The above and other objects, features, and advantages of the present disclosure should be more apparent from the following detailed description taken in conjunction with the accompanying drawings:

FIG. 1 is a diagram illustrating an autonomous driving control apparatus, according to an embodiment of the present disclosure;

FIG. 2 is a flowchart for describing an autonomous driving control method, according to an embodiment of the present disclosure;

FIG. 3 is a diagram illustrating a method of controlling a target vehicle in an autonomous driving control apparatus, according to an embodiment of the present disclosure;

FIG. 4 is a diagram showing a first prediction area and a second prediction area in an autonomous driving control apparatus, according to an embodiment of the present disclosure;

FIG. 5 is a diagram showing a difference between a first control mode and a second control mode in an autonomous driving control apparatus, according to an embodiment of the present disclosure;

FIG. 6 is a diagram illustrating pieces of input data capable of being used to control a target vehicle in an autonomous driving control apparatus, according to an embodiment of the present disclosure;

FIG. 7 is a diagram illustrating a method of passively controlling a target vehicle, to which a first control mode is applied, in an autonomous driving control apparatus according to an embodiment of the present disclosure;

FIG. 8 is a diagram illustrating a method of actively controlling a target vehicle, to which a first control mode is applied, in an autonomous driving control apparatus according to an embodiment of the present disclosure;

FIGS. 9 and 10 are flowcharts for describing a specific method of controlling a target vehicle in an autonomous driving control apparatus, according to an embodiment of the present disclosure; and

FIG. 11 is a diagram illustrating a computing system related to an autonomous driving control apparatus or autonomous driving control method, according to an embodiment of the present disclosure.

With regard to description of drawings, the same or similar components are marked by the same or similar reference signs.

### DETAILED DESCRIPTION

Hereinafter, some embodiments of the present disclosure will be described in detail with reference to the accompanying drawings. When reference numerals to components of each drawing are added, it should be noted that the same or equivalent components include the same reference numerals, although the components are indicated on another drawing. Furthermore, when the embodiments of the present disclosure are described, detailed descriptions associated with well-known functions or configurations have been omitted when the detailed descriptions may make subject matters of the present disclosure unnecessarily obscure. Hereinafter, various embodiments of the present disclosure may be described with reference to accompanying drawings. Accordingly, those of ordinary skill in the art should recognize that modification, equivalent, and/or alternative on the various embodiments described herein may be variously made without departing from the scope and spirit of the present disclosure. With regard to description of drawings, similar components may be marked by similar reference numerals.

When elements of an embodiment of the present disclosure are described, the terms first, second, A, B, (a), (b), and the like may be used herein. These terms are only used to distinguish one element from another element. The terms do not limit the corresponding elements irrespective of the nature, order, or priority of the corresponding elements. Furthermore, unless otherwise defined, all terms including technical and scientific terms used herein should be interpreted as is customary in the art to which the present disclosure belongs. It should be understood that terms used herein should be interpreted as including a meaning that is consistent with their meaning in the context of the present disclosure and the relevant art and should not be interpreted in an idealized or overly formal sense unless expressly so defined herein. For example, the terms, such as “first”, “second”, and the like used herein may refer to various components of various embodiments of the present disclosure but do not limit the elements. For example, “a first user device” and “a second user device” may indicate different user devices regardless of the order or priority thereof. For example, without departing the scope of the present disclosure, a first complement may be referred to as a second component, and similarly, a second complement may be referred to as a first complement.

In this specification, the expressions “possess”, “may possess”, “include” and “comprise”, or “may include” and “may comprise” used herein indicate existence of corresponding features (e.g., elements such as numeric values, functions, operations, or components) but do not exclude presence of additional features.

It should be understood that when an element (e.g., a first element) is referred to as being “(operatively or communicatively) coupled with/to” or “connected to” another element (e.g., a second element), the element may be directly coupled with/to or connected to the other element, or an intervening element (e.g., a third element) may be present. In contrast, when an element (e.g., a first element) is referred to as being “directly coupled with/to” or “directly connected to” another element (e.g., a second element), the element should be understood that there are no intervening element (e.g., a third element).

According to the situation, the expression “configured to” used herein may be used as, for example, the expression “suitable for”, “having the capacity to”, “designed to”, “adapted to”, “made to”, or “capable of”.

The term “configured to” must not mean only “specifically designed to” in hardware. Instead, the expression “a device configured to” may mean that the device is “capable of” operating together with another device or other components. For example, a “processor configured to (or set to) perform A, B, and C” may mean a dedicated processor (e.g., an embedded processor) for performing a corresponding operation or a generic-purpose processor (e.g., a central processing unit (CPU) or an application processor), which performs corresponding operations by executing one or more software programs stored in a memory device. The terms used in the present disclosure are only used to describe a specific embodiment and are not intended to limit the scope of the present disclosure. The terms of a singular form may include plural forms unless otherwise specified. All the terms used herein, which include technical or scientific terms, may include the same meaning that is generally understood by a person having ordinary skill in the art. It should be further understood that terms, which are defined in a dictionary and commonly used, should also be interpreted as is customary in the relevant related art and not in an idealized or overly formal detect unless expressly so defined herein in various embodiments of the present disclosure. In some cases, even though terms are terms which are defined in the specification, the terms may not be interpreted to exclude embodiments of the present disclosure. When a controller, module, component, device, element, or the like of the present disclosure is described as having a purpose or performing an operation, function, or the like, the controller, module, component, device, element, or the like should be considered herein as being “configured to” meet that purpose or to perform that operation or function. Each controller, module, component, device, element, and the like may separately embody or be included with a processor and a memory, such as a non-transitory computer readable media, as part of the apparatus.

In the present disclosure disclosed herein, the expressions “A or B”, “at least one of A or/and B”, or “one or more of A or/and B”, and the like used herein may include any and all combinations of one or more of the associated listed items. For example, the term “A or B”, “at least one of A and B”, or “at least one of A or B” may refer to all of the case (1) where at least one A is included, the case (2) where at least one B is included, or the case (3) where both of at least one A and at least one B are included. Moreover, in describing a component of an embodiment of the present disclosure, the expressions at least one of “A or B”, “at least one of A and B”, “at least one of A or B”, “A, B, or C”, “at least one of A, B, and C”, or “at least one of A, B, or C, or any combination thereof” may include any and all combinations of one or more of the associated listed items. In particular, expressions “at least one of A, B, or C, or any combination thereof” may include A, B, or C, or any combination thereof such as AB, ABC, or the like.

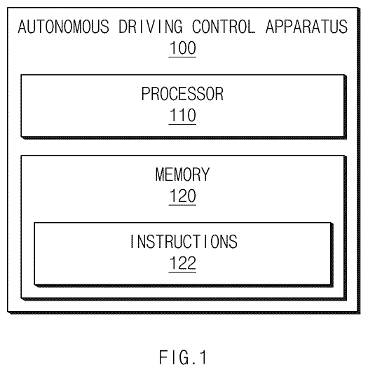

Hereinafter, embodiments of the present disclosure should be described in detail with reference to FIGS. 1-11.

FIG. 1 is a diagram illustrating an autonomous driving control apparatus, according to an embodiment of the present disclosure.

According to an embodiment, an autonomous driving control apparatus 100 may include a processor 110 and a memory 120 including instructions 122.

The autonomous driving control apparatus 100 may refer to a device that controls the speed of a vehicle to minimize energy consumption. For example, the autonomous driving control apparatus 100 may control a target vehicle in a control mode, in which the speed of the target vehicle follows a target speed section including a goal speed, to minimize the energy required for the target vehicle to drive based on a front road condition of the target vehicle. In detail, when a driver sets the goal speed, the autonomous driving control apparatus 100 may determine the target speed section including the goal speed. The autonomous driving control apparatus 100 may control the target vehicle such that the speed of the target vehicle is included in the target speed section. To control the target vehicle, the autonomous driving control apparatus 100 may determine control torque based on the vehicle's driving status (e.g., the weight of the target vehicle or the speed of the target vehicle) and the driver's state (e.g., driver's acceleration/deceleration tendency). The autonomous driving control apparatus 100 may control the target vehicle by applying the determined torque to a drive motor included in the vehicle.

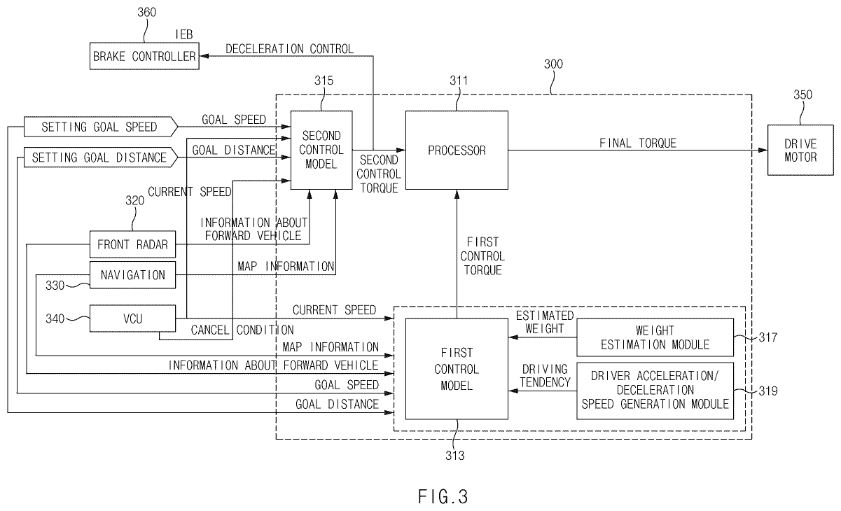

The autonomous driving control apparatus 100 may determine and/or predict the energy, which is capable of being consumed when the target vehicle drives on a front road, based on the driving status of the vehicle and the state of the driver. The autonomous driving control apparatus 100 may control the target vehicle in a first control mode and a second control mode to minimize the amount of energy determined and/or predicted. Here, the first control mode may indicate a mode for controlling the target vehicle such that the speed of the target vehicle follows the target speed section including the goal speed. The second control mode may indicate a mode for controlling the target vehicle such that the speed of the target vehicle follows the goal speed. The autonomous driving control apparatus 100 may determine the control torque to be applied to the target vehicle in the first control mode and the second control mode. A detailed description of determining the control torque is described in FIG. 3 below.

The autonomous driving control apparatus 100 is capable of controlling the target vehicle in at least one of the first control mode or the second control mode. For example, when the state of the target vehicle controlled in the second control mode satisfies a conversion condition, the autonomous driving control apparatus 100 may control the target vehicle in the first control mode. When the state of the target vehicle controlled by the first control mode satisfies an inverse conversion condition, the autonomous driving control apparatus 100 may release the first control mode applied to the target vehicle and may control the target vehicle in the second control mode.

Reasons for the autonomous driving control apparatus 100 to control the target vehicle in the first control mode and the second control mode may include the following reasons. For example, when the autonomous driving control apparatus 100 controls the target vehicle in the second control mode, the autonomous driving control apparatus 100 may control the target vehicle such that the target vehicle is capable of accurately following the goal speed. However, the autonomous driving control apparatus 100 may not allow the target vehicle to follow the goal speed while reducing the energy consumption of the target vehicle according to the front road condition of the target vehicle. In detail, in situations where the target vehicle is driving up a hill, or the target vehicle is avoiding the forward vehicle, the second control mode may be a mode for controlling the target vehicle such that the target vehicle follows only the goal speed. Meanwhile, when the autonomous driving control apparatus 100 controls the target vehicle in the first control mode, the autonomous driving control apparatus 100 may control the target vehicle such that the target vehicle is capable of accurately following the target speed section including the goal speed. In this case, the first control mode may be a mode for controlling the target vehicle such that the target vehicle is capable of following the target speed section by reflecting the front road condition of the target vehicle and at the same time reducing the energy consumption of the target vehicle. Furthermore, the first control mode may include a mode for controlling the target vehicle by reflecting the driver's tendencies.

The processor 110 may execute software and may control at least one other component (e.g., a hardware or a software component) connected to the processor 110. The processor 110 may also perform various data processing or operations. For example, the processor 110 may store, in the memory 120, a first driving status, a second driving status, a driver's state, front road information, and the predicted energy consumption according to the front road information.

For reference, the processor 110 may perform all operations performed by the autonomous driving control apparatus 100. Accordingly, for convenience of description in this specification, an operation performed by the autonomous driving control apparatus 100 are mainly described as an operation performed by the processor 110. Furthermore, for convenience of description in this specification, the processor 110 is mainly described as a single processor but is not limited thereto. For example, the autonomous driving control apparatus 100 may include at least one processor. The at least one processor may perform all operations related to controlling the target vehicle.

The memory 120 may temporarily and/or permanently store various pieces of data and/or information required to perform an operation of controlling the target vehicle. For example, the memory 120 may store a first driving status, a second driving status, a driver's state, front road information, and the predicted energy consumption according to the front road information.

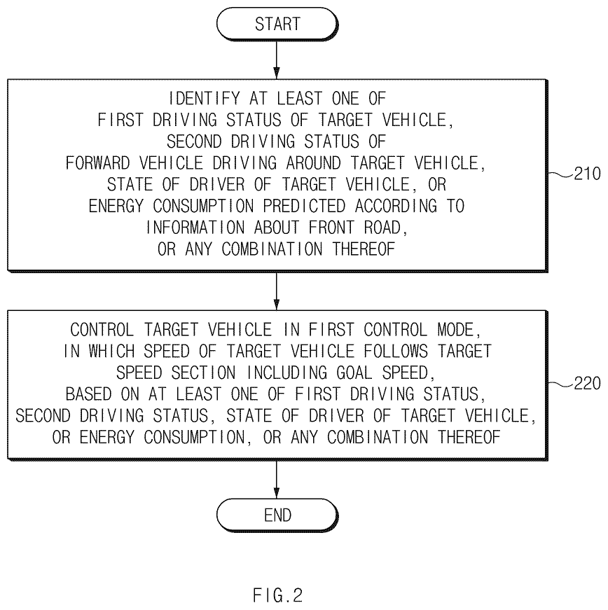

FIG. 2 is a flowchart for describing an autonomous driving control method, according to an embodiment of the present disclosure.

In operation 210, an autonomous driving control apparatus (e.g., the autonomous driving control apparatus 100 in FIG. 1) according to an embodiment may identify at least one of a first driving status of a target vehicle, a second driving status of a forward vehicle driving around the target vehicle, a state of a driver of the target vehicle, the energy consumption predicted according to information about the front road, or any combination thereof. For example, the first driving status may include a current speed of the target vehicle, the goal speed of the target vehicle, and the goal distance of the target vehicle. Here, the goal speed of the target vehicle and the goal distance of the target vehicle may be set by the driver. The second driving status may include information (e.g., a distance between the target vehicle and the forward vehicle, etc.) about the forward vehicle.

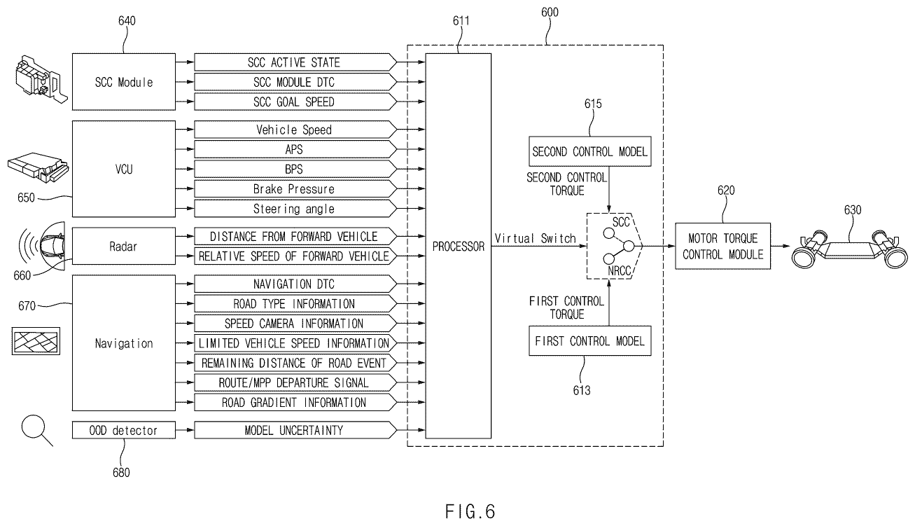

A control mode capable of being applied to the target vehicle may include a first control mode and a second control mode. The second control mode may include a smart cruise control (SCC) function among functions of the target vehicle. In other words, the second control mode may include a mode for controlling the target vehicle such that the speed of the target vehicle follows the goal speed depending on the state of the forward vehicle and the state of the target vehicle. The first control mode, which is different from the second control mode, may include an SCC function, to which a model trained through machine learning is applied, among the functions of the target vehicle. A detailed description related to the first control mode is described later in FIG. 3 below. Furthermore, a detailed description of a conversion condition is described later in FIG. 6 below.

In operation 220, the autonomous driving control apparatus may control the target vehicle in the first control mode, in which the speed of the target vehicle follows the target speed section including the goal speed, based on at least one of the first driving status, the second driving status, the state of the driver of the target vehicle, the energy consumption, or any combination thereof. The first control mode may further include the control mode of the target vehicle, to which the driver's state and predicted energy consumption are reflected, compared to the second control mode. Moreover, the first control mode may further include controlling the target vehicle such that the target vehicle follows the target speed section, which includes the goal speed, rather than the goal speed compared to the second control mode.

FIG. 3 is a diagram illustrating a method of controlling a target vehicle in an autonomous driving control apparatus, according to an embodiment of the present disclosure.

An autonomous driving control apparatus 300 according to an embodiment may include a processor 311, a first control model 313, a second control model 315, a weight estimation module 317, and the driver acceleration/deceleration speed generation module 319. A target vehicle, which is a control target of the autonomous driving control apparatus 300, may include a front RADAR 320, a navigation 330, a vehicle control unit (VCU) 340, a drive motor 350, and a brake controller 360. For reference, the target vehicle may further include a LiDAR device along with the RADAR 320. Accordingly, for convenience of description in the present disclosure, obtaining information about the forward vehicle from the front RADAR 320 is described as including obtaining information about the forward vehicle from LiDAR.

The autonomous driving control apparatus 300 may determine second control torque through the second control model 315. The second control model 315 may indicate a model that determines the second control torque. For example, the second control model may determine the second control torque based on input data (e.g., including a goal speed, a goal distance, a current speed, information about a forward vehicle, and map information). In detail, the second control torque may represent torque capable of being applied to the target vehicle in a second control mode. In other words, the autonomous driving control apparatus 300 may determine the second control torque of the second control mode based on the input data and the second control model 315. The autonomous driving control apparatus 300 may control the target vehicle such that the speed of the target vehicle follows the goal speed, by applying the second control torque to the target vehicle, to which the second control mode is applied.

The second control model 315 may include an SCC module, which determines the second control torque, based on the input signal provided from the front RADAR 320 and the navigation 330. For example, the second control model 315 may transmit the second control torque to the processor 311 and may transmit a deceleration control signal to the brake controller 360. Moreover, the second control model 315 may stop the first control model 313 from transmitting the first control torque to the processor 311. In this regard, the second control model 315 may stop the first control model 313 from transmitting first control torque to the processor 311 by receiving an inverse conversion condition from the autonomous driving control apparatus 300. Here, the brake controller 360 may indicate a device that generates hydraulic pressure to brake the target vehicle. The processor 311 may apply the second control torque, which is determined by the second control model 315, to the drive motor 350. In other words, the autonomous driving control apparatus 300 may control the target vehicle such that the speed of the target vehicle follows the goal speed, by applying the second control torque of the second control mode determined by the second control model 315 to the drive motor 350 of the target vehicle to which the second control mode is applied. Hereinafter, the detailed process in which the autonomous driving control apparatus 300 applies the second control torque to the target vehicle is described below.

The autonomous driving control apparatus 300 may identify a first driving status based on at least one of a goal speed received from driver, a goal distance, which is received together with the goal speed and which is a keeping distance between the forward vehicle and the target vehicle, the speed of target vehicle, map information of a front road obtained from the navigation 330 of the target vehicle, information of a brake pedal sensor (BPS) of the target vehicle, or any combination thereof. In other words, the first driving status may include pieces of information about the state of the target vehicle. The autonomous driving control apparatus 300 may identify a second driving status including the distance between the target vehicle and the forward vehicle based on at least one of the front RADAR 320, a LiDAR sensor, or any combination thereof, which is included in the target vehicle. In other words, the second driving status may include pieces of information about the state of the forward vehicle. The autonomous driving control apparatus 300 may determine the second control torque of the second control mode based on at least one of the first driving status, the second driving status, or any combination thereof. In detail, the autonomous driving control apparatus 300 may determine the second control torque by applying at least one of the first driving status, the second driving status, or any combination thereof to the second control model 315. The autonomous driving control apparatus 300 may control the target vehicle such that the speed of the target vehicle follows the goal speed, by applying the second control torque to the drive motor 350 of the target vehicle, to which the second control mode is applied.

The autonomous driving control apparatus 300 may determine first control torque through the first control model 313. The first control model 313 may indicate a model that determines the first control torque. For example, the first control model may determine the first control torque based on input data (e.g., including a goal speed, a goal distance, a current speed, information about the forward vehicle, map information, estimated weight, and a driving tendency). In detail, the first control torque may represent torque capable of being applied to the target vehicle in a first control mode. In other words, the autonomous driving control apparatus 300 may determine the first control torque of the first control mode based on the input data and the first control model 313. The autonomous driving control apparatus 300 may control the target vehicle such that the speed of the target vehicle follows a target speed section including the goal speed, by applying the first control torque to the target vehicle, to which the first control mode is applied.

The first control model 313 may include an SCC function, to which a model trained through machine learning is applied, based on input signals provided from the front RADAR 320, the navigation 330, the weight estimation module 317, and the driver acceleration/deceleration speed generation module 319. For example, the first control model 313 may transmit the first control torque to the processor 311. The processor 311 may apply the first control torque, which is determined by the first control model 313, to the drive motor 350. In other words, the autonomous driving control apparatus 300 may control the target vehicle such that the speed of the target vehicle follows the target speed section, by applying the first control torque of the first control mode determined by the first control model 313 to the drive motor 350 of the target vehicle to which the first control mode is applied. Hereinafter, the detailed process in which the autonomous driving control apparatus 300 applies the first control torque to the target vehicle is described below.

The autonomous driving control apparatus 300 may obtain the weight of the target vehicle by applying at least one of the acceleration of the target vehicle, the speed of the target vehicle, the longitudinal acceleration of the target vehicle, the wheel speed of the target vehicle, or any combination thereof to the weight estimation module 317. The autonomous driving control apparatus 300 may identify a first driving status based on the obtained weight of the target vehicle. However, the process of identifying the first driving status is not limited thereto. For example, the autonomous driving control apparatus 300 may identify the first driving status based on at least one of a goal speed received from a driver, a goal distance, which is received together with the goal speed and which is a keeping distance between the forward vehicle and the target vehicle, the speed of target vehicle, map information of a front road obtained from the navigation 330 of the target vehicle, BPS information of the target vehicle, the weight of the target vehicle, or any combination thereof.

The autonomous driving control apparatus 300 may identify the driver's state based on the driver's acceleration/deceleration tendency determined by the driver acceleration/deceleration speed generation module 319 repeatedly for a predetermined period of time. In other words, the driver's state may include the driver's habits or tendency to accelerate and decelerate the target vehicle.

The autonomous driving control apparatus 300 may determine the first control torque of the first control mode based on at least one of the first driving status, the second driving status, the driver's state, the weight of the target vehicle, energy consumption predicted depending on information about the front road, or any combination thereof. The autonomous driving control apparatus 300 may control the target vehicle such that the speed of the target vehicle follows the target speed section, by applying the first control torque to the drive motor 350 of the target vehicle, to which the first control mode is applied.

For example, the first control model 313 may include a torque calculation model trained through machine learning methods. For example, the first control model 313 may include the torque calculation model that determines and/or obtains control torque for reducing energy consumption based on (or as an input) at least one of the first driving status (e.g., a current speed, map information, a goal speed, and a goal distance), the second driving status (e.g., information about of the forward vehicle), the driver's state (e.g., driving tendency), the weight of the target vehicle (e.g., estimated weight), energy consumption predicted based on information about the front road, or any combination thereof. The autonomous driving control apparatus 300 may obtain the first control torque of the first control mode from the first control model 313. The autonomous driving control apparatus 300 may control the target vehicle such that the speed of the target vehicle follows the target speed section, by applying the first control torque to the target vehicle, to which the first control mode is applied.

The autonomous driving control apparatus 300 may train the first control model 313. For example, the first control model 313 may include a neural network. The neural network may include a plurality of layers, and each layer may include a plurality of nodes. The node may include a node value determined based on an activation function. A node on any layer may be connected to a node (e.g., another node) on another layer through a link (e.g., a connection edge) with a connection weight. The node value of a node may be propagated to other nodes through the link. In an inference operation of the neural network, node values may be forward propagated from the previous layer to the next layer.

For example, the forward propagation operation in the first control model 313 may indicate an operation of propagating node values based on input data in a direction from an input layer of the first control model 313 to an output layer of the first control model 313. In other words, the node value of the corresponding node may be propagated (e.g., forward propagated) to a node (e.g., the next node) of the next layer connected through the node and the connection edge. For example, the node may receive a value weighted by a connection weight from the previous node (e.g., a plurality of nodes) connected through the connection edge.

The node value of a node may be determined based on applying an activation function to the sum (e.g., weighted sum) of weighted values received from previous nodes. For example, a parameter of a neural network may include the connection weight described above. The parameters of the neural network may be updated such that a value of an objective function value described later changes in a targeted direction (e.g., a direction in which a loss is minimized).

The learned first control model 313 may indicate a model trained through machine learning and may be a trained machine learning model that outputs training output (e.g., the first control torque) from training input (e.g., the first driving status, the second driving status, the driver's state, the target vehicle's weight, and energy consumption predicted depending on front road information). The machine learning model (e.g., the trained first control model 313) may be created through machine learning. For example, the learning algorithm may include supervised learning, unsupervised learning, semi-supervised learning, or reinforcement learning, but is not limited to the above example.

The machine learning model may include a plurality of artificial neural network layers. The artificial neural network may be one of a deep neural network (DNN), a convolutional neural network (CNN), U-Net for image segmentation (U-net), a recurrent neural network (RNN), a restricted Boltzmann machine (RBM), a deep belief network (DBN), a bidirectional recurrent deep neural network (BRDNN), a deep Q-network, or at least one combination among combinations thereof but may not be limited to the above-described example.

The autonomous driving control apparatus 300 may apply at least one of the first control torque or the second control torque, which is delivered to the processor 311, to the drive motor 350 as final torque. For example, the autonomous driving control apparatus 300 may apply at least one of the first control torque or the second control torque to the drive motor 350 as the final torque, based on a control mode applied to the target vehicle. However, the method in which the autonomous driving control apparatus 300 applies the final torque to the drive motor 350 is not limited thereto. For example, the autonomous driving control apparatus 300 may apply the final torque, which is summed by applying weights to the first control torque and the second control torque, to the drive motor 350.

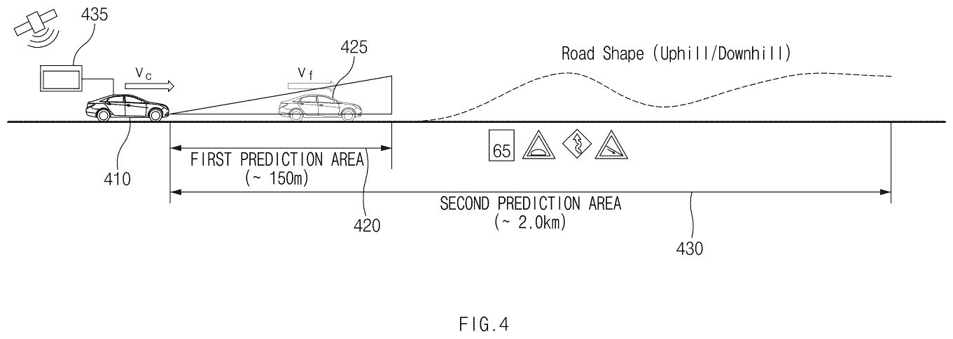

FIG. 4 is a diagram showing a first prediction area and a second prediction area in an autonomous driving control apparatus, according to an embodiment of the present disclosure.

An autonomous driving control apparatus (e.g., the autonomous driving control apparatus 300 of FIG. 3) according to an embodiment may determine a first prediction area 420 and a second prediction area 430. For example, the first prediction area 420 may indicate an area up to 150 m in front of the target vehicle 410, where information about a forward vehicle 425 is capable of being obtained through the front RADAR or LiDAR of a target vehicle 410. The second prediction area 430 may indicate an area up to 2 km in front of the target vehicle 410, where energy consumption predicted depending on information about a front road is capable of being obtained through navigation 435 of the target vehicle 410.

For example, the autonomous driving control apparatus may determine the first prediction area 420, which is an area where the forward vehicle 425 is capable of being identified by at least one of a radar sensor, a LiDAR sensor, or any combination thereof, which is included in the target vehicle 410. The autonomous driving control apparatus may determine the second prediction area, which is an area spaced from a location of the target vehicle 410 by a predetermined distance (e.g., 2.0 km) in map information of the front road obtained from the navigation 435 of the target vehicle 410.

For example, the autonomous driving control apparatus may control the target vehicle 410 in a first control mode based on a second driving status, which is obtained through the first prediction area 420, and the predicted energy consumption obtained through the second prediction area 430. In detail, the autonomous driving control apparatus may determine at least one of a distance between the target vehicle 410 and the forward vehicle 425, a relative speed between the target vehicle 410 and the forward vehicle 425, or any combination thereof by identifying the forward vehicle 425 in the first prediction area 420. In this way, the autonomous driving control apparatus may identify a second driving status, which is information about the state of the forward vehicle 425. The autonomous driving control apparatus may determine at least one of the gradient of the front road, the curvature of the front road, or any combination thereof based on map information in the second prediction area 430. The autonomous driving control apparatus may determine the predicted energy consumption based on information of the front road based on the gradient of the front road and the curvature of the front road.

The autonomous driving control apparatus may control the target vehicle 410 in the first control mode based on at least one of the distance between the target vehicle 410 and the forward vehicle 425, the relative speed between the target vehicle 410 and the forward vehicle 425, the gradient of the front road, the curvature of the front road, or any combination thereof.

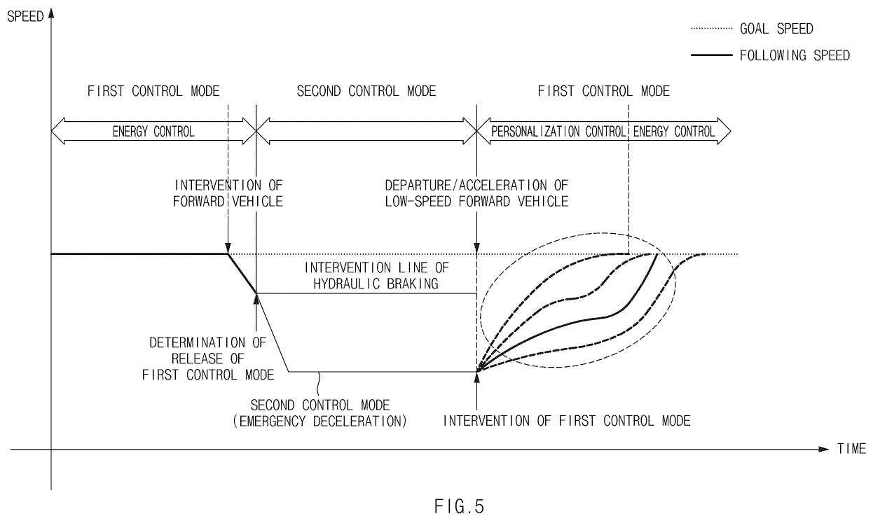

FIG. 5 is a diagram showing a difference between a first control mode and a second control mode in an autonomous driving control apparatus, according to an embodiment of the present disclosure.

The autonomous driving control apparatus (e.g., the autonomous driving control apparatus 300 in FIG. 3) according to an embodiment may control a target vehicle in a first control mode or a second control mode. Hereinafter, in FIG. 5, a graph showing a change in speed of a target vehicle according to the first control mode and the second control mode is described.

The autonomous driving control apparatus may control the target vehicle in the first control mode. Here, the speed of the target vehicle may be equal to a goal speed such that energy consumption is minimized. In particular, the speed of the target vehicle may be included in a target speed section in the first control mode. While controlling the target vehicle in the first control mode, the autonomous driving control apparatus may identify the intervention of a forward vehicle in front of the target vehicle. In this case, the autonomous driving control apparatus may determine whether to release the first control mode.

While simultaneously releasing the first control mode, the autonomous driving control apparatus may control the target vehicle in the second control mode. In detail, the autonomous driving control apparatus may transmit a braking signal to a brake controller through a second control model regarding the second control mode. Moreover, based on the fact that a distance between the target vehicle and the forward vehicle is smaller than or equal to a predetermined distance, the autonomous driving control apparatus may control emergency deceleration of the target vehicle in the second control mode. In a situation where the target vehicle is controlled in the second control mode, the autonomous driving control apparatus may identify departure or acceleration of the forward vehicle. In this case, the autonomous driving control apparatus may determine a control mode of the target vehicle as a first control mode.

While simultaneously releasing the second control mode, the autonomous driving control apparatus may control the target vehicle in the first control mode. For example, the autonomous driving control apparatus may control the target vehicle such that energy consumption is minimized, and the speed of the target vehicle is included in the target speed section, by applying the first control mode to the target vehicle. In particular, when the autonomous driving control apparatus identifies departure or acceleration of the forward vehicle, the autonomous driving control apparatus may control the target vehicle with personalization control or energy control to include the speed of the target vehicle in the target speed section. In detail, when increasing the speed of the target vehicle in the personalization control step of the first control mode, the autonomous driving control apparatus may increase the speed of the target vehicle with various speed profiles, by reflecting the driver's acceleration/deceleration tendencies. In particular, in the personalization control step, the autonomous driving control apparatus may increase the speed of the target vehicle with the first control torque obtained from the first control model. When identifying that the speed of the target vehicle is included in the target speed section, the autonomous driving control apparatus may control the target vehicle with energy control. Here, while controlling the target vehicle such that the target vehicle's speed is included in the target speed section, the autonomous driving control apparatus may simultaneously control the target vehicle such that energy is effectively used based on the front road condition of the target vehicle (i.e., such that energy consumption is minimized). A detailed description of a conversion process of a first control mode and a second control mode is described in detail in FIG. 6 below.

FIG. 6 is a diagram illustrating pieces of input data capable of being used to control a target vehicle in an autonomous driving control apparatus, according to an embodiment of the present disclosure.

An autonomous driving control apparatus 600 according to an embodiment may include a processor 611, a first control model 613, and a second control model 615. The autonomous driving control apparatus 600 may transmit at least one of first control torque obtained from the first control model 613 or second control torque obtained from the second control model 615 to a motor torque control module 620 based on a signal obtained from the processor 611. Here, the motor torque control module 620 may be a module included in a target vehicle 630. Moreover, the target vehicle 630 may include an electric vehicle that moves by applying control torque (at least one of the first control torque or the second control torque) to a drive motor.

The autonomous driving control apparatus 600 may receive information or pieces of data for identifying a first driving status and a second driving status from an SCC module 640, a VCU 650, a RADAR 660, navigation 670, and an out-of-distribution (OOD) detector 680. In detail, the autonomous driving control apparatus 600 may determine a conversion condition and an inverse conversion condition based on pieces of information received from the SCC module 640, the VCU 650, the RADAR 660, the navigation 670, and the OOD detector 680.

For example, the conversion condition may indicate a condition that a control mode applicable to the target vehicle 630 is capable of being converted from the second control mode to the first control mode. The autonomous driving control apparatus may release the second control mode applied to the target vehicle based on satisfying the conversion condition that the control mode applicable to the target vehicle is capable of being converted from the second control mode to the first control mode. On the other hand, the inverse conversion condition may indicate a condition that the control mode applicable to the target vehicle 630 is capable of being converted from the first control mode to the second control mode. Hereinafter, a detailed description of a method in which the autonomous driving control apparatus 600 determines the conversion condition and the inverse conversion condition is described.

The conversion condition may be satisfied when the state of the target vehicle 630 satisfies all of the following conditions. For example, the conversion condition may include at least one of activation of a cruise switch, activation of a speed control switch, a normal operating state of a RADAR and a navigation device, a state where a manual lever of the target vehicle 630 is in a forward gear (D), a state where a driving road of the target vehicle 630 is a highway or expressway, a state where a driving speed is greater than or equal to 30 kph and is smaller than or equal to 160 kph, a case where a gradient of a current driving road is within the 15% range, a case where a current speed of the target vehicle 630 is within a range of 10 kph compared to a cruise setting speed, a case where the target vehicle 630 is on a navigation setting route, a case where brake hydraulic pressure is less than or equal to 0.2 bar, or a case where there is no transfer of a prohibition command regarding determination of the first control torque of the first control model, or any combination thereof. The above-described conversion condition may be determined by the autonomous driving control apparatus 600 based on pieces of information received from the SCC module 640, the VCU 650, the RADAR 660, the navigation 670, and the OOD detector 680. When all of the above-described conditions are satisfied, the autonomous driving control apparatus 600 may determine activation of the conversion condition. When the conversion condition is satisfied, the autonomous driving control apparatus 600 may change the control mode of the target vehicle 630 from the second control mode to the first control mode.

The inverse conversion condition may be determined based on a first driving status, a second driving status, and a driver's state. In detail, the inverse conversion condition may be satisfied when the state of the target vehicle 630 satisfies at least one of the following conditions. For example, the inverse conversion condition may include at least one of deactivation of a cruise switch, deactivation of a speed control switch, a state where a diagnostic trouble code (DTC) occurs in a RADAR or navigation device, a state where a manual lever is in a neutral (N) or reverse (R), a case where a driving road is other than a highway or expressway, a state where a driver operates an accelerator pedal or a brake pedal (e.g., APS>0.1% or BPS>0.1%), a case where a current driving speed is less than 30 kph or greater than 160 kph, a case where a gradient of a current driving road is less than-15% or greater than +15%, a case where a current speed is less than a cruise setting speed by −20 kph or greater than the cruise setting speed by +20 kph, a case where a distance from a forward vehicle is less than 100 m and a relative speed of a forward vehicle is less than or equal to −30 kph, a case where a forward vehicle is detected within the distance of 30 m from the forward vehicle, a case where a deceleration event is detected within 300 m ahead, a case where the target vehicle 630 deviates from the setting route of a navigation device, a case where the brake pressure is greater than or equal to 0.8 bar, or a case where a steering angle of a steering wheel is greater than or equal to 15°, or any combination thereof. The above-described inverse conversion condition may be determined by the autonomous driving control apparatus 600 based on pieces of information received from the SCC module 640, the VCU 650, the RADAR 660, the navigation 670, and the OOD detector 680. When all of the above conditions are satisfied, the autonomous driving control apparatus 600 may determine activation of the inverse conversion condition. When the inverse conversion condition is satisfied, the autonomous driving control apparatus 600 may change the control mode of the target vehicle 630 from the first control mode to the second control mode.

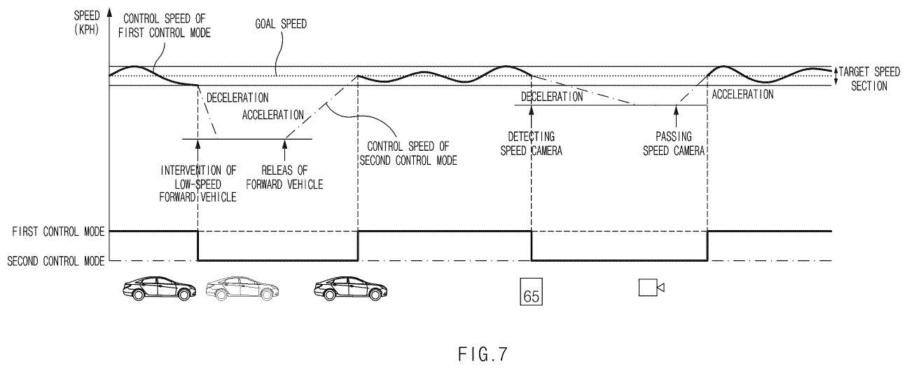

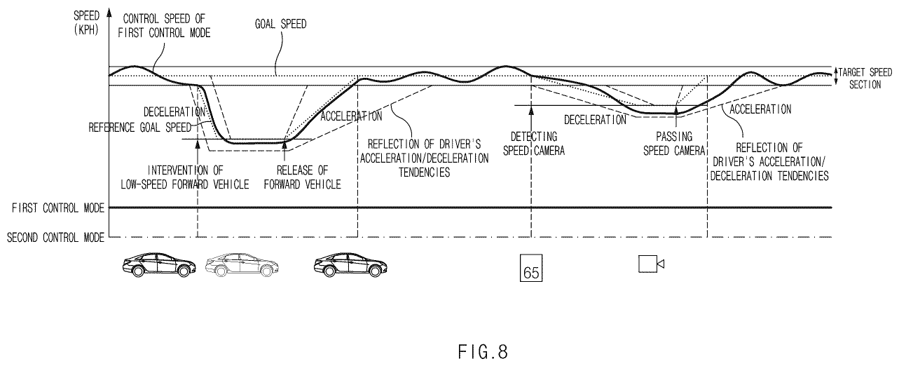

The autonomous driving control apparatus 600 may determine the sensitivity of the inverse conversion condition in relation to the inverse conversion condition. For example, the autonomous driving control apparatus 600 may determine the sensitivity of the inverse conversion condition based on an external device (e.g., a surveillance camera) for detecting a speed at a predetermined distance being identified based on a location of the target vehicle 630, or a distance between the forward vehicle and the target vehicle 630 being smaller than or equal to a predetermined distance. In detail, the autonomous driving control apparatus 600 may actively or passively determine the sensitivity of the inverse conversion condition. When the sensitivity of the inverse conversion condition is active sensitivity, the autonomous driving control apparatus 600 may immediately change the control mode of the target vehicle 630 from the first control mode to the second control mode when an external device is identified, or a distance to the forward vehicle is smaller than or equal to the predetermined distance. On the other hand, when the sensitivity of the inverse conversion condition is passive sensitivity, the autonomous driving control apparatus 600 may maintain the control mode of the target vehicle 630 as the first control mode when the external device is identified, and a distance to the forward vehicle is smaller than or equal to the predetermined distance. A detailed description thereof is described with reference to FIGS. 7 and 8 below.

FIG. 7 is a diagram illustrating a method of passively controlling a target vehicle, to which a first control mode is applied, in an autonomous driving control apparatus according to an embodiment of the present disclosure.

An autonomous driving control apparatus (e.g., the autonomous driving control apparatus 300 in FIG. 3) according to an embodiment may passively control a target vehicle in a first control mode. Here, passively controlling the target vehicle in the first control mode may include the autonomous driving control apparatus actively converting a control mode from the first control mode to a second control mode. For example, when the sensitivity of the inverse conversion condition is active sensitivity, the autonomous driving control apparatus may immediately change the control mode of the target vehicle from the first control mode to the second control mode when an external device (e.g., a speed camera) is identified, or a distance to the forward vehicle is smaller than or equal to a predetermined distance. In other words, when the sensitivity of the inverse conversion condition is active sensitivity, the autonomous driving control apparatus may passively control the target vehicle in the first control mode. Moreover, the autonomous driving control apparatus may control the target vehicle for the purpose of minimizing energy consumption of the target vehicle by passively controlling the target vehicle in the first control mode. Hereinafter, a speed change graph of the target vehicle over time shown in FIG. 7 is described.

The autonomous driving control apparatus may set a target speed section including a goal speed to control the target vehicle in the first control mode. Here, the autonomous driving control apparatus may control the target vehicle in the first control mode such that the speed of the target vehicle follows the set target speed section. The speed of the target vehicle to which the first control mode is applied may be greater than, less than, or equal to the goal speed in the target speed section.

The autonomous driving control apparatus may identify the sensitivity of the inverse conversion condition by identifying (e.g., identifying that a distance to the forward vehicle is smaller than or equal to the predetermined distance) the intervention of a low-speed forward vehicle. When the sensitivity of the inverse conversion condition is active sensitivity, the autonomous driving control apparatus may determine whether to release the first control mode. In detail, the autonomous driving control apparatus may release the first control mode applied to the target vehicle by identifying that the distance between the forward vehicle and the target vehicle is smaller than or equal to the predetermined distance from the second driving status. However, when the sensitivity of the inverse conversion condition is active and the intervention of a low-speed forward vehicle is identified, the operation of the autonomous driving control apparatus is not limited thereto. For example, the autonomous driving control apparatus may control the target vehicle such that the speed of the target vehicle follows the target speed section, by applying the first control torque, to which the sensitivity is reflected, to the target vehicle, to which the first control mode is applied.

While simultaneously releasing the first control mode, the autonomous driving control apparatus may control the target vehicle in the second control mode. In detail, the autonomous driving control apparatus may transmit a braking signal to a brake controller through a second control model regarding the second control mode. Moreover, based on the fact that a distance between the target vehicle and the forward vehicle is smaller than or equal to a predetermined distance, autonomous driving control apparatus may control emergency deceleration of the target vehicle in the second control mode. In a situation where the target vehicle is controlled in the second control mode, the autonomous driving control apparatus may identify departure or acceleration of the forward vehicle. In this case, the autonomous driving control apparatus may determine a control mode of the target vehicle as the first control mode.

The autonomous driving control apparatus may identify the sensitivity of the inverse conversion condition by identifying the external device. When the sensitivity of the inverse conversion condition is active sensitivity, the autonomous driving control apparatus may determine whether to release the first control mode. In detail, the autonomous driving control apparatus may release the first control mode applied to the target vehicle by identifying an external device detecting a speed at a predetermined distance based on the location of the target vehicle from the first driving status.

However, when the sensitivity of the inverse conversion condition is active and an external autonomous driving control apparatus is identified, the operation of the autonomous driving control apparatus is not limited thereto. For example, the autonomous driving control apparatus may control the target vehicle such that the speed of the target vehicle follows the target speed section, by applying the first control torque, to which the sensitivity is reflected, to the target vehicle, to which the first control mode is applied.

While simultaneously releasing the first control mode, the autonomous driving control apparatus may control the target vehicle in the second control mode. In detail, the autonomous driving control apparatus may transmit a braking signal to a brake controller through a second control model regarding the second control mode. Furthermore, the autonomous driving control apparatus may control emergency deceleration of the target vehicle in the second control mode by identifying the external autonomous driving control apparatus. In a situation of controlling the target vehicle in the second control mode, the autonomous driving control apparatus may identify that the target vehicle passes the external device. In this case, the autonomous driving control apparatus may determine a control mode of the target vehicle as the first control mode.

FIG. 8 is a diagram illustrating a method of actively controlling a target vehicle, to which a first control mode is applied, in an autonomous driving control apparatus according to an embodiment of the present disclosure.

An autonomous driving control apparatus (e.g., the autonomous driving control apparatus 300 in FIG. 3) according to an embodiment may actively control a target vehicle in a first control mode. Here, actively controlling the target vehicle in the first control mode may include the autonomous driving control apparatus passively converting a control mode from the first control mode to a second control mode. For example, when the sensitivity of the inverse conversion condition is passive sensitivity, the autonomous driving control apparatus may not immediately change the control mode of the target vehicle from the first control mode to the second control mode when an external device (e.g., a speed camera) is identified, or a distance to the forward vehicle is smaller than or equal to a predetermined distance. In other words, when the sensitivity of the inverse conversion condition is passive sensitivity, the autonomous driving control apparatus may actively control the target vehicle in the first control mode. Moreover, the autonomous driving control apparatus may control the target vehicle for the purpose of minimizing energy consumption of the target vehicle by actively controlling the target vehicle in the first control mode. Hereinafter, a speed change graph of the target vehicle over time shown in FIG. 8 is described.

The autonomous driving control apparatus may set a target speed section including a goal speed to control the target vehicle in the first control mode. Here, the autonomous driving control apparatus may control the target vehicle in the first control mode such that the speed of the target vehicle follows the set target speed section. The speed of the target vehicle to which the first control mode is applied may be greater than, less than, or equal to the goal speed in the target speed section.

The autonomous driving control apparatus may identify the sensitivity of the inverse conversion condition by identifying (e.g., identifying that a distance to the forward vehicle is smaller than or equal to the predetermined distance) the intervention of a low-speed forward vehicle. Furthermore, the autonomous driving control apparatus may modify the target speed section depending on the distance between the low-speed forward vehicle and the target vehicle by identifying the intervention of a low-speed forward vehicle. When the sensitivity of the inverse conversion condition is passive sensitivity, the autonomous driving control apparatus may determine whether to maintain the first control mode. In detail, the autonomous driving control apparatus may maintain the first control mode applied to the target vehicle by identifying that the distance between the forward vehicle and the target vehicle is smaller than or equal to the predetermined distance from the second driving status. In other words, the autonomous driving control apparatus may control the target vehicle such that the speed of the target vehicle follows the target speed section, by applying the first control torque, to which the sensitivity is reflected, to the target vehicle, to which the first control mode is applied.

The autonomous driving control apparatus may transmit a braking signal to a brake controller through a first control model regarding the first control mode. Based on the fact that a distance between the target vehicle and the forward vehicle is smaller than or equal to a predetermined distance, the autonomous driving control apparatus may control emergency deceleration of the target vehicle in the first control mode. In a situation where the target vehicle is controlled in the first control mode, the autonomous driving control apparatus may identify departure or acceleration of the forward vehicle. In this case, the autonomous driving control apparatus may determine the acceleration of the target vehicle in the first control mode.

The autonomous driving control apparatus may control the target vehicle such that energy consumption is minimized, and the speed of the target vehicle is included in the target speed section, by applying the first control mode to the target vehicle. In particular, when identifying departure or acceleration of the forward vehicle, the autonomous driving control apparatus may control the target vehicle with personalization control or energy control to include the speed of the target vehicle in the existing target speed section (e.g., a target speed section at a point time preceding a time point of identifying the intervention of a low-speed forward vehicle). In detail, when increasing the speed of the target vehicle in the personalization control step the first control mode, the autonomous driving control apparatus may increase the speed of the target vehicle with various speed profiles, by reflecting the driver's acceleration/deceleration tendencies. In a personalization control step, the autonomous driving control apparatus may increase the speed of the target vehicle with the first control torque obtained from the first control model.

When identifying that the speed of the target vehicle is included in the existing target speed section, the autonomous driving control apparatus may control the target vehicle with energy control. Here, while controlling the target vehicle such that the target vehicle's speed is included in the target speed section, the autonomous driving control apparatus may simultaneously control the target vehicle such that energy is effectively used depending on the front road condition of the target vehicle (i.e., such that energy consumption is minimized).

The autonomous driving control apparatus may identify the sensitivity of the inverse conversion condition by identifying the external device. When the sensitivity of the inverse conversion condition is passive sensitivity, the autonomous driving control apparatus may determine whether to maintain the first control mode. In detail, the autonomous driving control apparatus may maintain the first control mode applied to the target vehicle by identifying an external autonomous driving control apparatus detecting a speed at a predetermined distance based on the location of the target vehicle from the first driving status. For example, the autonomous driving control apparatus may control the target vehicle such that the speed of the target vehicle follows the target speed section, by applying the first control torque, to which the sensitivity is reflected, to the target vehicle, to which the first control mode is applied.

The autonomous driving control apparatus may transmit a braking signal to a brake controller through a first control control mode. Furthermore, the model regarding the first autonomous driving control apparatus may control deceleration of the target vehicle in the first control mode by identifying the external autonomous driving control apparatus. In a situation of controlling the target vehicle in the first control mode, the autonomous driving control apparatus may identify that the target vehicle passes the external device.

When identifying that the target vehicle passes the external device, the autonomous driving control apparatus may control the target vehicle with personalization control or energy control to include the speed of the target vehicle in the existing target speed section (e.g., a target speed section at a point time preceding a time point of identifying the intervention of a low-speed forward vehicle). In detail, when increasing the speed of the target vehicle in the personalization control step of the first control mode, autonomous driving control apparatus may increase the speed of the target vehicle with various speed profiles, by reflecting the driver's acceleration/deceleration tendencies. In a personalization control step, the autonomous driving control apparatus may increase the speed of the target vehicle with the first control torque obtained from the first control model.

When identifying that the speed of the target vehicle is included in the existing target speed section, the autonomous driving control apparatus may control the target vehicle with energy control. Here, while controlling the target vehicle such that the target vehicle's speed is included in the target speed section, the autonomous driving control apparatus may simultaneously control the target vehicle such that energy is effectively used based on the front road condition of the target vehicle.

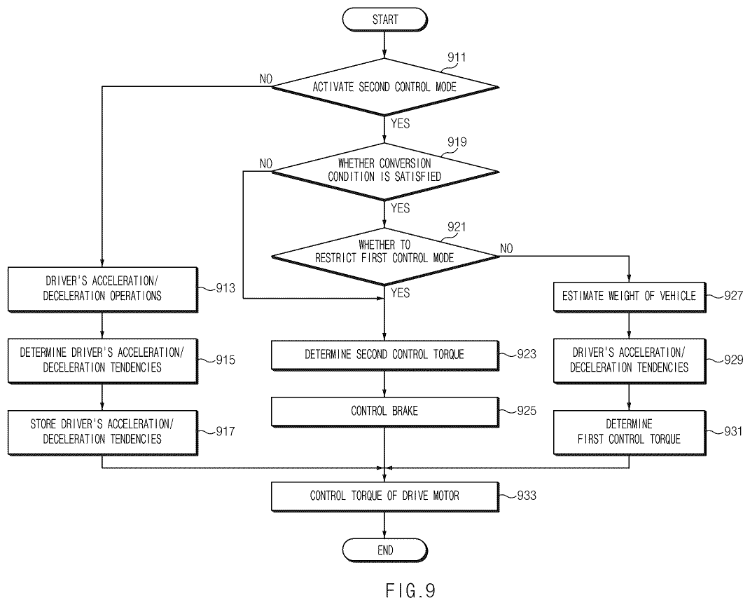

FIG. 9 is a flowchart for describing a specific method of controlling a target vehicle in an autonomous driving control apparatus, according to an embodiment of the present disclosure.

In operation 911, an autonomous driving control apparatus (e.g., the autonomous driving control apparatus 300 of FIG. 3) according to an embodiment may identify whether a second control mode is activated. For example, the autonomous driving control apparatus may identify the activation of the second control mode based on at least one of a first driving status, a second driving status, or any combination thereof.

In operations 913 to 917, when the second control mode is not activated (NO in operation 911), the autonomous driving control apparatus may determine a driver's acceleration/deceleration tendencies related to the driver's acceleration/deceleration operations based on the second control mode being deactivated. For example, the autonomous driving control apparatus may identify driving information for determining the driver's driving tendencies based on the fact that at least one of the first driving status, the second driving status, or any combination thereof is not identified. Here, the driving information may include information about the driver's acceleration/deceleration operations. The autonomous driving control apparatus may store the driver's acceleration/deceleration tendencies obtained from the driving information in the target vehicle at predetermined time intervals. For example, the autonomous driving control apparatus may obtain and/or determine the driver's acceleration/deceleration tendencies by applying the driver's acceleration/deceleration operations to a driver acceleration/deceleration decision model. The autonomous driving control apparatus may store the obtained and/or determined acceleration/deceleration tendencies of the driver. The autonomous driving control apparatus may utilize the stored acceleration/deceleration tendencies of the driver in a first control mode below.

In operation 919, when the second control mode is not activated (YES in operation 911), the autonomous driving control apparatus may determine whether a conversion condition is satisfied, based on the second control mode being activated. For example, the autonomous driving control apparatus may control the target vehicle from the second control mode to the first control mode based on the conversion condition described in FIG. 6. Here, the autonomous driving control apparatus may control the target vehicle in the second control mode based on the conversion condition not being satisfied (NO in operation 919). In detail, in operation 923, the autonomous driving control apparatus may determine the second control torque of the second control mode based on at least one of the first driving status, the second driving status, or any combination thereof. In operation 925, the autonomous driving control apparatus 925 may control the target vehicle such that the speed of the target vehicle follows the goal speed, by applying the second control torque to the target vehicle, to which the second control mode is applied.

In operation 921, when the conversion condition is satisfied (YES in operation 919), the autonomous driving control apparatus may determine whether to restrict the first control mode based on the conversion condition being satisfied. For example, whether to restrict the first control mode may be determined under the inverse conversion condition described in FIG. 6.

In operations 927 to 931, when the first control mode is not restricted (NO in operation 921), the autonomous driving control apparatus may perform operations for determining first control torque. In detail, the autonomous driving control apparatus may determine the first control torque of the first control mode based on at least one of the first driving status, the second driving status, the driver's state, or any combination thereof and may control the target vehicle such that the speed of the target vehicle follows the target speed section by applying the first control torque to the target vehicle to which the first control mode is applied. For example, to determine the first control torque, the autonomous driving control apparatus may determine the weight of a vehicle and the driver's acceleration/deceleration tendencies, in addition to the first driving status, the second driving status, and the driver's state.

In operation 933, the autonomous driving control apparatus may apply the second control torque to a drive motor in the second control mode or may apply the first control torque to the drive motor in the first control mode. The autonomous driving control apparatus may control the speed of the target vehicle to minimize energy consumption by applying control torque to the drive motor for each control mode described above.

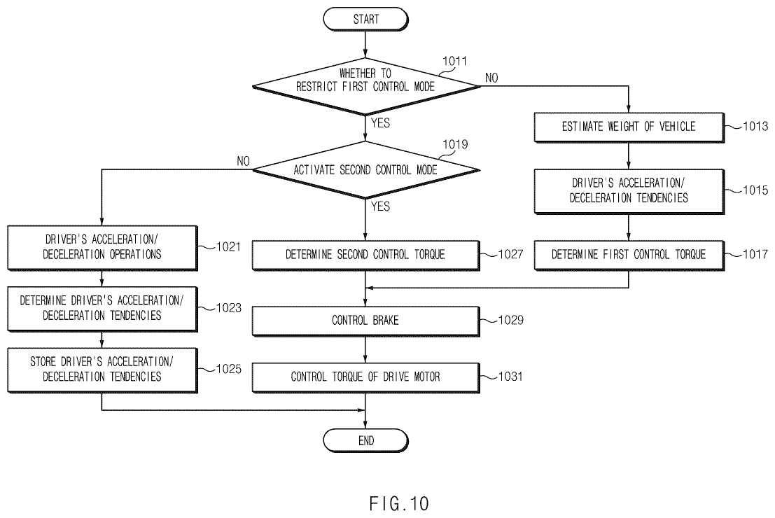

FIG. 10 is a flowchart for describing a specific method of controlling a target vehicle in an autonomous driving control apparatus, according to an embodiment of the present disclosure.

In operation 1011, an autonomous driving control apparatus (e.g., the autonomous driving control apparatus 300 of FIG. 3) according to an embodiment may determine whether to restrict a first control mode. For example, whether to restrict the first control mode may be determined under the inverse conversion condition described in FIG. 6.

In operations 1013 to 1017, when it is not restricted to the first control mode (NO in operation 1011), the autonomous driving control apparatus may perform operations for determining first control torque. In detail, the autonomous driving control apparatus may determine the first control torque of the first control mode based on at least one of the first driving status, the second driving status, the driver's state, or any combination thereof and may control the target vehicle such that the speed of the target vehicle follows the target speed section by applying the first control torque to the target vehicle to which the first control mode is applied.

In operation 1019, when it is restricted to the first control mode (YES in operation 1011), the autonomous driving control apparatus may identify whether the second control mode is activated. For example, the autonomous driving control apparatus may identify the activation of the second control mode based on at least one of a first driving status, or a second driving status, or any combination thereof.

In operations 1021 to 1025, when the second control mode is not activated (NO in operation 1019), the autonomous driving control apparatus may determine a driver's acceleration/deceleration tendencies related to the driver's acceleration/deceleration operations based on the second control mode being deactivated. For example, the autonomous driving control apparatus may identify driving information for determining the driver's driving tendencies based on the fact that at least one of the first driving status, the second driving status, or any combination thereof is not identified. The autonomous driving control apparatus may utilize the stored acceleration/deceleration tendencies of the driver in a first control mode below.

In operation 1027, when the second control mode is activated (YES in operation 1019), the autonomous driving control apparatus may determine the second control torque of the second control mode based on at least one of the first driving status, the second driving status, or any combination thereof. In operation 1029, the autonomous driving control apparatus 925 may control the target vehicle such that the speed of the target vehicle follows the goal speed, by applying the second control torque to the target vehicle, to which the second control mode is applied.

In operation 1031, the autonomous driving control apparatus may apply the first control torque to a drive motor in the first control mode or may apply the second control torque to the drive motor in the second control mode. The autonomous driving control apparatus may control the speed of the target vehicle to minimize energy consumption by applying control torque to the drive motor for each control mode described above.

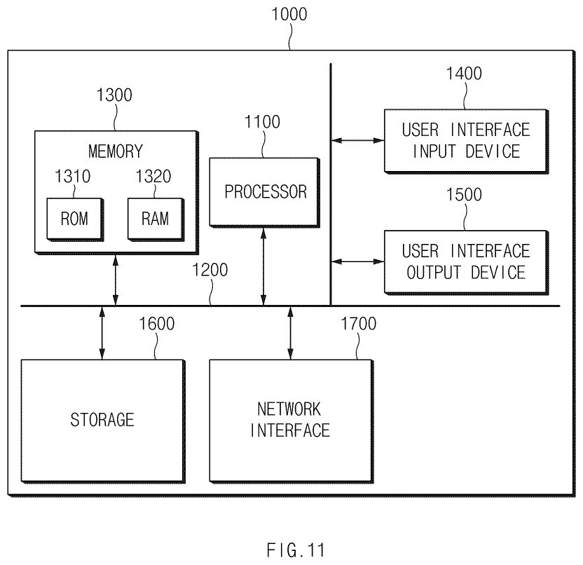

FIG. 11 is a diagram illustrating a computing system related to an autonomous driving control apparatus or autonomous driving control method, according to an embodiment of the present disclosure.

Referring to FIG. 11, a computing system 1000 related to an autonomous driving control apparatus or autonomous driving control method may include at least one processor 1100, a memory 1300, a user interface input device 1400, a user interface output device 1500, a storage 1600, and a network interface 1700, which are connected to each other via a bus 1200.

The processor 1100 may be a central processing unit (CPU) or a semiconductor device that processes instructions stored in the memory 1300 and/or the storage 1600. Each of the memory 1300 and the storage 1600 may include various types of volatile or nonvolatile storage media. For example, the memory 1300 may include a read only memory (ROM) and a random access memory (RAM).

Accordingly, the operations of the method or algorithm described in connection with the embodiments disclosed in the specification may be directly implemented with a hardware module, a software module, or a combination of the hardware module and the software module, which is executed by the processor 1100. The software module may reside on a storage medium (i.e., the memory 1300 and/or the storage 1600) such as a random access memory 1320 (RAM), a flash memory, a read only memory 1310 (ROM), an erasable and programmable ROM (EPROM), an electrically EPROM (EEPROM), a register, a hard disk drive, a removable disc, or a compact disc-ROM (CD-ROM).

The storage medium may be coupled to the processor 1100. The processor 1100 may read out information from the storage medium and may write information in the storage medium. Alternatively, the storage medium may be integrated with the processor 1100. The processor and storage medium may be implemented with an application specific integrated circuit (ASIC). The ASIC may be provided in a user terminal. Alternatively, the processor and storage medium may be implemented with separate components in the user terminal.

The above description is merely an example of the technical idea of the present disclosure, and various modifications and modifications may be made by one having ordinary skill in the art without departing from the essential characteristic of the present disclosure.

The above-described embodiments may be implemented with hardware elements, software elements, and/or a combination of hardware elements and software elements. For example, the devices, methods, and components described in embodiments of the present disclosure may be implemented by using general-use computers or special-purpose computers, such as a processor, a controller, an arithmetic logic unit (ALU), a digital signal processor, a microcomputer, a field programmable array (FRA), a programmable logic unit (PLU), a microprocessor, or any device which may execute instructions and respond. A processing device may perform an operating system (OS) or a software application running on the OS. Further, the processing device may access, store, manipulate, process and generate data in response to execution of software. It should be understood by those having ordinary skill in the art that although a single processing device may be illustrated for convenience of understanding, the processing device may include a plurality of processing elements and/or a plurality of types of processing elements. For example, the processing device may include a plurality of processors or one processor and one controller. Also, the processing device may include a different processing configuration, such as a parallel processor.

Software may include computer programs, codes, instructions or one or more combinations thereof and configure a processing device to operate in a desired manner or independently or collectively control the processing device. Software and/or data may be permanently or temporarily embodied in any type of machine, components, physical equipment, virtual equipment, computer storage media or units, or transmitted signal waves so as to be interpreted by the processing device or to provide instructions or data to the processing device. Software may be dispersed throughout computer systems connected over networks and be stored or executed in a dispersion manner. Software and data may be recorded in a computer-readable storage medium.

The methods according to the above-described embodiments may be recorded in a computer-readable medium including program instructions that are executable through various computer devices. The computer-readable medium may also include program instructions, data files, data structures, or any combination thereof. The program instructions recorded in the medium may be designed and configured specially for the embodiments of the present disclosure or may be known and available to those having ordinary skill in computer software. The computer-readable medium may include hardware devices, which are specially configured to store and execute program instructions, such as magnetic media (e.g., a hard disk, a floppy disk, or a magnetic tape), optical recording media (e.g., CD-ROM and DVD), magneto-optical media (e.g., a floptical disk), read only memories (ROMs), random access memories (RAMs), and flash memories. Examples of computer programs include not only machine language codes created by a compiler, but also high-level language codes that are capable of being executed by a computer by using an interpreter or the like.

The hardware device described above may be configured to act as one or more software modules to perform the operations of the above-described embodiments of the present disclosure, or vice versa.

Even though the embodiments are described with reference to restricted drawings, it may be obviously to one having ordinary skill in the art that the embodiments are variously changed or modified based on the above description. For example, adequate effects may be achieved even when the foregoing processes and methods are carried out in different order than described above, and/or the aforementioned elements, such as systems, structures, devices, or circuits, are combined or coupled in different forms and modes than as described above or be substituted d or switched with other components or equivalents.

Therefore, other implements, other embodiments, and equivalents to claims are within the scope of the present disclosure.

Accordingly, embodiments of the present disclosure are intended not to limit but to explain the technical idea of the present disclosure, and the scope and spirit of the present disclosure is not limited by the above embodiments. The scope of protection of the present disclosure should be construed by the attached claims, and all equivalents thereof should be construed as being included within the scope of the present disclosure.

Descriptions of an autonomous driving control apparatus according to an embodiment of the present disclosure and an autonomous driving control method thereof are as follows.

According to at least one of embodiments of the present disclosure, it is possible to realizes a cruise control function with improved overall performance compared to the cruise control function of following a goal speed. It is also possible to perform acceleration and deceleration according to a driver's state, by controlling a target vehicle in a control mode, in which the speed of the target vehicle follows a target speed section, based on a driving status of the target vehicle, a driving status of the forward vehicle, the state of the driver, and the predicted energy consumption.

Moreover, according to at least one of embodiments of the present disclosure, it is possible to identify the context of driving by recognizing the shape of the front road, events on a front road, and traffic volume on the front road. It is also possible to improve fuel efficiency by changing driving speed based on the identified context, by controlling the target vehicle based on a first prediction area capable of identifying the forward vehicle and a second prediction area determined by map information.

Furthermore, according to at least one of embodiments of the present disclosure, it is possible to provide a control mode that reflects energy consumption and the driver's acceleration/deceleration tendency according to the driver's needs by applying the sensitivity of a conversion condition between a first control mode and a second control mode to control torque.

Besides, a variety of effects directly or indirectly understood through the present disclosure may be provided.

Hereinabove, although the present disclosure was described with reference to embodiments and the accompanying drawings, the present disclosure is not limited thereto but may be variously modified and altered by those having ordinary skill in the art to which the present disclosure pertains without departing from the spirit and scope of the present disclosure claimed in the following claims.

What is claimed is:

1. An autonomous driving control apparatus comprising:
a memory configured to store computer-executable instructions; and
at least one processor configured, by executing the computer-executable instructions by accessing the memory, to
identify at least one of a first driving status of a target vehicle, a second driving status of a forward vehicle driving around the target vehicle, a state of a driver of the target vehicle, energy consumption predicted according to information about a front road, or any combination thereof, and
control the target vehicle in a first control mode, based on at least one of the first driving status, the second driving status, the state of the driver of the target vehicle, the energy consumption, or any combination thereof, wherein in the first control mode, a speed of the target vehicle follows a target speed section including a goal speed.

2. The autonomous driving control apparatus of claim 1, wherein the at least one processor is configured to:
identify the first driving status based on at least one of the goal speed received from the driver, a goal distance, the speed of target vehicle, map information of the front road obtained from a navigation of the target vehicle, information of a brake pedal sensor (BPS) of the target vehicle, or any combination thereof, wherein the goal distance is received together with the goal speed and is a keeping distance between the forward vehicle and the target vehicle;
identify the second driving status including a distance between the target vehicle and the forward vehicle based on at least one of a RADAR sensor, a LiDAR sensor, or any combination thereof, wherein the RADAR sensor, the LiDAR sensor, or any combination thereof is included in the target vehicle;
determine second control torque of a second control mode, based on at least one of the first driving status, the second driving status, or any combination thereof, wherein in the second control mode, the speed of the target vehicle follows the goal speed; and
control the target vehicle such that the speed of the target vehicle follows the goal speed, by applying the second control torque to the target vehicle.

3. The autonomous driving control apparatus of claim 1, wherein the at least one processor is configured to:
determine a first prediction area, wherein the first prediction area is an area where the forward vehicle is capable of being identified by at least one of a RADAR sensor, a LiDAR sensor, or any combination thereof, and the RADAR sensor, the LiDAR sensor, or any combination thereof is included in the target vehicle;
determine a second prediction area, wherein the second prediction area is an area spaced from a location of the target vehicle by a predetermined distance in map information of the front road obtained from a navigation of the target vehicle; and
control the target vehicle in the first control mode based on the second driving status and the predicted energy consumption, wherein the second driving status is obtained through the first prediction area, and the predicted energy consumption is obtained through the second prediction area.

4. The autonomous driving control apparatus of claim 3, wherein the at least one processor is configured to:
determine at least one of a distance between the target vehicle and the forward vehicle, a relative speed between the target vehicle and the forward vehicle, or any combination thereof by identifying the forward vehicle in the first prediction area;
determine at least one of a gradient of the front road, curvature of the front road, or any combination thereof based on the map information in the second prediction area; and
control the target vehicle in the first control mode based on at least one of the distance between the target vehicle and the forward vehicle, the relative speed between the target vehicle and the forward vehicle, the gradient of the front road, the curvature of the front road, or any combination thereof.

5. The autonomous driving control apparatus of claim 2, wherein the at least one processor is configured to:
identify the first driving status based on weight of the target vehicle determined based on at least one of acceleration of the target vehicle, the speed of the target vehicle, longitudinal acceleration of the target vehicle, a wheel speed of the target vehicle, or any combination thereof;
identify the state of the driver based on an acceleration/deceleration tendency of the driver determined repeatedly for a predetermined period of time;
determine first control torque of the first control mode based on at least one of the first driving status, the second driving status, the state of the driver, or any combination thereof; and
control the target vehicle such that the speed of the target vehicle follows the target speed section, by applying the first control torque to the target vehicle.

6. The autonomous driving control apparatus of claim 5, wherein the at least one processor is configured to:
release the first control mode applied to the target vehicle by identifying an external device configured to detect a speed at a predetermined distance based on a location of the target vehicle from the first driving status.

7. The autonomous driving control apparatus of claim 5, wherein the at least one processor is configured to:
release the first control mode applied to the target vehicle by identifying that the distance between the forward vehicle and the target vehicle is smaller than or equal to a predetermined distance from the second driving status.

8. The autonomous driving control apparatus of claim 5, wherein the at least one processor is configured to:
determine sensitivity of an inverse conversion condition that a control mode of the target vehicle is capable of being converted from the first control mode to the second control mode, based on an external device configured to detect a speed at a predetermined distance being identified based on a location of the target vehicle, or the distance between the forward vehicle and the target vehicle being smaller than or equal to a predetermined distance; and
control the target vehicle such that the speed of the target vehicle follows the target speed section, by applying the first control torque, to which the sensitivity is reflected, to the target vehicle, wherein the first control mode is applied to the target vehicle.

9. The autonomous driving control apparatus of claim 2, wherein the at least one processor is configured to:
release the first control mode applied to the target vehicle; and
control the target vehicle in the second control mode based on the target vehicle,
wherein the first control mode is applied to the target vehicle, satisfying an inverse conversion condition that a control mode of the target vehicle is capable of being converted from the first control mode to the second control mode, and
wherein the inverse conversion condition is determined by the first driving status, the second driving status, and the state of the driver.

10. The autonomous driving control apparatus of claim 1, wherein the at least one processor is configured to:
identify driving information for determining a driving tendency of the driver based on at least one of the first driving status, the second driving status, or any combination thereof not being identified; and
store an acceleration/deceleration tendency of the driver obtained from the driving information in the target vehicle at a predetermined time interval.

11. The autonomous driving control apparatus of claim 1, wherein the at least one processor is configured to:
obtain first control torque of the first control mode by applying the first driving status, the second driving status, the state of the driver, and weight of the target vehicle to a torque calculation model trained to determine control torque for reducing energy consumption; and
control the target vehicle such that the speed of the target vehicle follows the target speed section, by applying the first control torque to the target vehicle.

12. The autonomous driving control apparatus of claim 5, wherein the target vehicle includes an electric vehicle configured to move by applying the first control torque to a drive motor.

13. An autonomous driving control method, the method comprising:
identifying at least one of a first driving status of a target vehicle, a second driving status of a forward vehicle driving around the target vehicle, a state of a driver of the target vehicle, energy consumption predicted according to information about a front road, or any combination thereof; and
controlling the target vehicle in a first control mode, based on at least one of the first driving status, the second driving status, the state of the driver of the target vehicle, the energy consumption, or any combination thereof, wherein in the first control mode, a speed of the target vehicle follows a target speed section including a goal speed.

14. The method of claim 13, wherein controlling the target vehicle in the first control mode includes:
identifying the first driving status based on at least speed received from the driver, a goal one of the goal distance, the speed of target vehicle, map information of the front road obtained from a navigation of the target vehicle, information of a BPS of the target vehicle, or any combination thereof, wherein the goal distance is received together with the goal speed and which is a keeping distance between the forward vehicle and the target vehicle;
identifying the second a driving status including distance between the target vehicle and the forward vehicle based on at least one of a RADAR sensor, a LiDAR sensor, or any combination thereof, wherein the RADAR sensor, the LiDAR sensor, or any combination thereof is included in the target vehicle;
determining second control torque of a second control mode, based on at least one of the first driving status, the second driving status, or any combination thereof, wherein in the second control mode, the speed of the target vehicle follows the goal speed; and
controlling the target vehicle such that the speed of the target vehicle follows the goal speed, by applying the second control torque to the target vehicle.

15. The method of claim 13, wherein controlling the target vehicle in the first control mode includes:
determining a first prediction area, wherein the first prediction area is an area where the forward vehicle is capable of being identified by at least one of a RADAR sensor, a LiDAR sensor, or any combination thereof, and the RADAR sensor, the LiDAR sensor, or any combination thereof is included in the target vehicle;
determining a second prediction area, wherein the second prediction area is an area spaced from a location of the target vehicle by a predetermined distance in map information of the front road obtained from a navigation of the target vehicle;
controlling the target vehicle in the first control mode based on the second driving status and the predicted energy consumption, wherein the second driving status is obtained through the first prediction area, and the predicted energy consumption is obtained through the second prediction area;
determining at least one of a distance between the target vehicle and the forward vehicle, a relative speed between the target vehicle and the forward vehicle, or any combination thereof by identifying the forward vehicle in the first prediction area;
determining at least one of a gradient of the front road, curvature of the front road, or any combination thereof based on the map information in the second prediction area; and
controlling the target vehicle in the first control mode based on at least one of the distance between the target vehicle and the forward vehicle, the relative speed between the target vehicle and the forward vehicle, the gradient of the front road, the curvature of the front road, or any combination thereof.

16. The method of claim 13, wherein controlling the target vehicle in the first control mode includes:
identifying the first driving status based on weight of the target vehicle determined based on at least one of acceleration of the target vehicle, the speed of the target acceleration of the target vehicle, a vehicle, longitudinal wheel speed of the target vehicle, or any combination thereof;
identifying the state of the driver based on an acceleration/deceleration tendency of the driver determined repeatedly for a predetermined period of time;
determining first control torque of the first control mode based on at least one of the first driving status, the second driving status, the state of the driver, or any combination thereof; and
controlling the target vehicle such that the speed of the target vehicle follows the target speed section, by applying the first control torque to the target vehicle.

17. The method of claim 16, wherein controlling the target vehicle in the first control mode includes:
releasing the first control mode applied to the target vehicle by identifying an external device configured to detect a speed at a predetermined distance based on a location of the target vehicle from the first driving status;
releasing the first control mode applied to the target vehicle by identifying that a distance between the forward vehicle and the target vehicle is smaller than or equal to a predetermined distance from the second driving status;
determining sensitivity of an inverse conversion condition that a control mode of the target vehicle is capable of being converted from the first control mode to a second control mode, based on an external device configured to detect a speed at a predetermined distance being identified based on a location of the target vehicle, or the distance between the forward vehicle and the target vehicle being smaller than or equal to a predetermined distance; and
controlling the target vehicle such that the speed of the target vehicle follows the target speed section, by applying the first control torque, to which the sensitivity is reflected, to the target vehicle, wherein the first control mode is applied to the target vehicle.

18. The method of claim 14, wherein controlling the target vehicle in the first control mode includes:
releasing the first control mode applied to the target vehicle; and
controlling the target vehicle in the second control mode based on the target vehicle,
wherein the first control mode is applied to the target vehicle, satisfying an inverse conversion condition that a control mode of the target vehicle is capable of being converted from the first control mode to the second control mode, and
wherein the inverse conversion condition is determined by the first driving status, the second driving status, and a state of the driver.

19. The method of claim 13, further comprising:
identifying driving information for determining a driving tendency of the driver based on at least one of the first driving status, the second driving status, or any combination thereof not being identified; and
storing an acceleration/deceleration tendency of the driver obtained from the driving information in the target vehicle at a predetermined time interval.

20. The method of claim 13, wherein controlling the target vehicle in the first control mode includes:
obtaining first control torque of the first control mode by applying the first driving status, the second driving status, the state of the driver, and weight of the target vehicle to a torque calculation model trained to determine control torque for reducing energy consumption; and
controlling the target vehicle such that the speed of the target vehicle follows the target speed section, by applying the first control torque to the target vehicle.
